(19) United States
(12) Patent Application Publication
(10) Pub. No.: US 2025/0342579 A1
(43) Pub. Date: Nov. 6, 2025

(54) METHOD AND SYSTEM FOR PERFORMING QUALITY CONTROL OF OBJECTS IN AN APPARATUS WHICH PRODUCES THE OBJECTS IN CONTINUOUS CYCLE

(71) Applicant: SACMI COOPERATIVA MECCANICI IMOLA SOCIETA' COOPERATIVA, IMOLA (BOLOGNA) (IT)

(72) Inventors: Marco CASADIO, Imola (Bologna) (IT); Donato LAICO, Imola (Bologna) (IT); Antonio GUADAGNINI, Massa Lombarda (Ravenna) (IT)

(21) Appl. No.: 18/870,217

(22) PCT Filed: May 29, 2023
(86) PCT No.: PCT/IB2023/055479

§ 371 Date: Nov. 27, 2024

(30) Foreign Application Priority Data
May 30, 2022 (IT) 102022000011345

(51) Int. Cl. G06T 7/00; G06T 7/73; G06V 10/762; G06V 10/764; G06V 10/774

(52) U.S. Cl. CPC G06T 7/001; G06T 7/74; G06V 10/762; G06V 10/764; G06V 10/774; G06T 2207/20021; G06T 2207/20081; G06T 2207/30108; G06T 2207/30204; G06V 2201/06

(57) ABSTRACT

A method for performing quality control of objects in an apparatus which produces the objects in continuous cycle, comprises the following steps: for each object (O), capturing an image (I); for each image, applying a first processing step (102A), for attributing the image and the corresponding object to one of the two following categories: defective objects category and non-defective objects category; if the image is attributed to the defective objects category, applying to image data related to that image a second processing step (102B), and further classifying the image and the corresponding object according to a plurality of defect categories.

### TECHNICAL FIELD

This invention relates to a method and a system for performing quality control of objects in an apparatus which produces the objects in continuous cycle.

### BACKGROUND ART

Quality control is of utmost importance in production lines, especially in high-output production lines.

In these lines, some objects may be defective and a quality check must be performed on the objects before they leave the factory so that the defective objects can be removed.

Quality control may consist of a manual visual inspection. This method, however, is not sufficiently precise and is usually replaced by automated visual inspection.

Known in the prior art are methods for automatically detecting defects in the objects. In these methods, one or more images of the object to be inspected are captured by optical devices and, based on the image data, any defects are identified as far as possible. Furthermore, after the initial process by which the defects are identified, these method often also involve further data processing and analysis to classify the defects identified.

In this context, patent documents US20090324057A1, CN110349150, CN110838107, US2013129185 and WO2004111618 describe automated inspection methods for detecting defects. Patent document

US2021/010953A1 discloses a system for high-speed examination and inspection of objects using X-rays; this system is focused on the inspection of integrated circuits, by analysing the various parts of the integrated circuit. However, this system is rather complex and does not allow to provide a real time (on-line) control quality of objects that are manufactured with a high production rate (this is a typical situation in the field of rigid packaging).

Indeed, in this field there is an ever growing need for a method capable of performing quality control of objects with greater precision and in a shorter space of time.

It must be said that this invention may be applied in all fields where quality control of objects is necessary, for example, the field of rigid packaging.

In this field, the products that are checked for defects may be made from plastic (caps, parisons, containers . . . ) or other materials (glass, aluminium, jars, tins . . . ).

### DISCLOSURE OF THE INVENTION

This disclosure has for an aim to overcome the above-mentioned drawbacks of the prior art by providing a method and a system for performing quality control of objects in an apparatus which produces the objects in continuous cycle.

This aim is fully achieved by the method and the system of this disclosure, for performing quality control of objects in an apparatus which produces the objects in continuous cycle, as characterized in the appended claims. According to an aspect of it, this disclosure provides a method for performing quality control of objects in an apparatus which produces the objects in continuous cycle. The method comprises a step of feeding the objects individually to an inspecting station. The method comprises a step of capturing an image of each object positioned in the inspecting station.

In an example, the images are taken by an optical device. The optical device may include a camera. The optical device may include an illuminator for illuminating the object in the inspecting station. The optical device views the object positioned in the inspecting station. Hence, an image of the object positioned in the inspecting station is taken by the optical device (camera), when the object is illuminated by the illuminator. Preferably, the illuminator illuminates the object with light in the spectrum of visible light or IR or UV.

The method also comprises a step, for each image, of applying a first processing step. The first processing step is performed for attributing the image and the corresponding object to one of the two following categories: defective objects category and non-defective objects category.

If the image is attributed to the defective objects category, the method comprises a step of applying a second processing step to image data related to that image, and further classifying the image and the corresponding object according to a plurality of defect categories. The step of classifying the image and the corresponding object is carried out based on a plurality of identification features. In an example, the plurality of identification features is extracted from the image data. The plurality of identification features is extracted from the image data in real time, or, alternatively, in post processing. Hence, the image data are processed, to extract a plurality of identification features.

This solution allows separating the defective objects from the non-defective objects and further classifying the defects in a particularly efficient manner.

It should be noted that, thanks to the possibility of identifying different types of defects in the objects, this disclosure also involves taking action to adjust the production apparatus responsive to the defects detected. This action may be automated or manual. That way, the production apparatus can be provided with a feedback control system. For example, a criterion based on the identification of defects (for example, a criterion which involves avoiding a certain type of defect) can be used to update, or adjust, one or more control parameters (which control corresponding steps of the continuous-cycle production, and/or to update the setting of one or more components of the apparatus.

In an example, the optical device includes a camera. In one example, the image captured for each object is representative of the visible appearance of the object. The image is taken by the camera.

In an example, the method comprises a step of storing in a database the images which are attributed to the defective objects category. This solution allows having a database to refer to, for example, during the step of classifying.

As a result of the processing, wherein the plurality of identification features is extracted from each image data, an array is generated for each image data, wherein the array includes the values of the identification features for that image data. Such an array constitutes a fingerprint for the image data, and hence for the respective object. The plurality of identification features defines a workspace, wherein each identification feature constitutes a dimension of the workspace. Hence, the workspace has multiple dimensions. Each dimension of the plurality of working space dimensions corresponds to a feature of the plurality of identification features extracted from the image data of each image. In particular, values of said identification characteristics extracted for each image define the position of the image data of each image in the working space.

In an example, an unsupervised clustering is used in the second processing step. During the unsupervised clustering, each image data (image data related to image captured for each object) may be represented as a (data) point in the working space (in fact, the array of that image data provides a plurality of coordinates in the working space). In an example, in the unsupervised clustering, the defect categories are generated by grouping data points that have similar locations in the working space. This solution allows identifying different defect categories, including the categories not considered before the start of the quality control. Further, the step of generating defect categories allows ascertaining the category with the highest number of defects.

By “unsupervised clustering” is meant a grouping system for subdividing the data points in the working space into groups in an unsupervised manner.

It should be noted that classifying (or identifying) the defects according to this disclosure lends itself to making the classification (or identification) results available to users in a particularly simple and easy-to-read manner. For example, the output of the unsupervised classification may be a report (or a map) regarding different types of defects identified in the objects (for example, considering a population of objects). The output need not, therefore, be checked by specialized technical personnel and even a non-specialized operator can read the output to see what the different types of defects are and the number of defects in each defect category.

According to another aspect of this disclosure, unsupervised classification (that is, the step of clustering) can be started at any time. That way, it is also possible to create a system of “continuous classification”.

In effect, through unsupervised clustering, classification of the objects can be repeated each time an object is identified as being defective, or at predetermine time intervals, or after a certain number of objects have been identified as being defective, or according to other predetermined criteria.

According to another aspect, if an object is classified as defective in the first processing step but, in the second processing step, is not recognized as belonging to one of the defect categories already identified, the system (thanks to unsupervised clustering) can create a new defect category (cluster) in the working space. Thus, it is possible to add new defect categories to update existing categories continuously (that is, the whole time the apparatus is in operation).

In an example, the images attributed to the non-defective objects category are excluded from the storing step.

This solution allows using less database space. Moreover, by not storing the data relating to non-defective objects, the quality control process is faster.

In an example, the first processing step provides position information. Position information relates to the position of a defect in each defective object.

In an example, the position information is fed to the second processing step. This information can be used to classify the defects.

Further, in an example, the plurality of identification features includes at least one feature representative of the position information.

In an example, the first processing step is performed by a machine-learned model. The machine-learned model is trained to attribute each image to the defective objects category or to the non-defective objects category. The machine-learned model is trained based on training data.

The training data may include only images of non-defective objects. This solution allows training the machine-learned model using images of non-defective objects. Defects can thus be identified without necessitating a complete database of defects.

Moreover, the first processing step may include, for each image, extracting diagnostic markers from the image data and applying predetermined diagnostic rules (that is, algorithms).

In an example, the first processing step, at a first stage, includes a machine-learned model. The machine-learned model is trained to attribute each image to the defective objects category or to the non-defective objects category. The machine-learned model is trained based on training data. In an example, the training data may include only images of non-defective objects. The first processing step, at a second stage, may also include, for each image, extracting diagnostic markers from the image data and applying predetermined diagnostic rules (that is, algorithms).

Furthermore, both the outcome of the first stage and the outcome of the second stage of the first processing step are taken into consideration for attributing the image and the corresponding object to the defective objects category or to the non-defective objects category.

In an example, in the second processing step, output data of both the first stage and the second stage of the first processing step are received and processed in combination with each other.

In an example, in the first processing step, both the first stage and the second stage are applied to the image data taken from each object.

In another example, the image data of each object may, in the first processing step, be divided into a first subset and a second subset according to predetermined criteria. In this solution, for each object, the first stage is applied to the first subset and the second stage is applied to the second subset.

In an example, the first processing step may also include a plurality of tasks which provides a corresponding plurality of conditions relating to the objects to be checked according to a predetermined sequence. In this solution, a first group of tasks is performed by the machine-learned model, and a second group of tasks is performed by extracting diagnostic markers from the image data and applying predetermined diagnostic rules.

According to an aspect of it, this disclosure also provides a system for performing quality control of objects in an apparatus which produces the objects in continuous cycle. The system for performing quality control of objects in an apparatus which produces the objects in continuous cycle, (hereinafter, the system) comprises an optical device. The optical device is configured to capture an image of each object located in an inspecting station. The system may comprise a conveyor. The conveyor is configured for feeding objects individually to the inspecting station. The system also comprises a processing unit. The processing unit is programmed to process each image in a first processing step. The processing unit is programmed to attribute the image and the corresponding object to one of the two following categories: defective objects category and non-defective objects category.

The processing unit is also configured to process, in a second processing step, responsive to an outcome of the first processing step, image data related to each image attributed to the defective objects category, so as to classify the image and the corresponding object according to a plurality of defect categories. The second processing step is performed on the basis of a plurality of identification features. In an example, the plurality of identification features is extracted from the image data.

In an example, the system comprises a storage unit. The storage unit is configured to store the images which are attributed to the defective objects category in a database.

In an example, the processing unit is configured to perform an unsupervised clustering in the second processing step. The unsupervised clustering is programmed to define a workspace. The workspace has multiple dimensions. Each dimension corresponds to one feature of the plurality of identification features extracted from the image data of each image. Values of said identification features extracted for each image define the position of the image data of each image in the working space, so that each image data is illustrated as a data point in the working space. Therefore, unsupervised clustering is programmed for illustrating each image data as a data point in a working space. The unsupervised clustering is programmed to generate the defect categories by grouping data points that have similar locations in the working space.

In an example, the processing unit is configured to obtain position information related to the position of a defect in each defective object in the first processing step.

In the first processing step, the processing unit may include a machine- learned model. The machine-learned model is trained to attribute each image to the defective objects category or to the non-defective objects category. In an example, the machine-learned model is trained based on training data. In an example, the training data may include only images of non-defective objects.

Moreover, in the first processing step, the processing unit may include, for each image, extracting diagnostic markers from the image data and applying predetermined diagnostic rules (that is, algorithms).

In the first processing step, the processing unit may include a machine-learned model at a first stage. The machine-learned model is trained to attribute each image to the defective objects category or to the non- defective objects category. The machine-learned model is trained based on training data. In an example, the training data may include only images of non-defective objects.

Moreover, in the first processing step, the processing unit may include, for each image, extracting diagnostic markers from the image data and applying predetermined diagnostic rules at a second stage.

In an example, both the outcome of the first stage and the outcome of the second stage of the first processing step are taken into consideration for attributing the image and the corresponding object to the defective objects category or to the non-defective objects category.

In an example, in the second processing step, output data of both the first stage and the second stage of the first processing step are received and processed in combination with each other.

According to an aspect of it, this disclosure provides an apparatus for producing objects in continuous cycle. The apparatus comprises one or more machines for producing the objects. The apparatus also comprises a system for performing quality control of the objects. The system for performing quality control of the objects is made according to this disclosure.

According to an aspect of it, this disclosure provides a computer program. The computer program comprises instructions configured for performing quality control of objects in an apparatus which produces the objects in continuous cycle according to this disclosure.

### BRIEF DESCRIPTION OF DRAWINGS

These and other features will become more apparent from the following description of a preferred embodiment, illustrated by way of non-limiting example in the accompanying drawings, in which:

FIG. 1 illustrates a system according to this disclosure, for performing quality control of objects in an apparatus which produces the objects in continuous cycle;

FIG. 2 illustrates the step of processing an image of an object captured to perform quality control;

FIG. 3 illustrates the first and the second stage of the processing step.

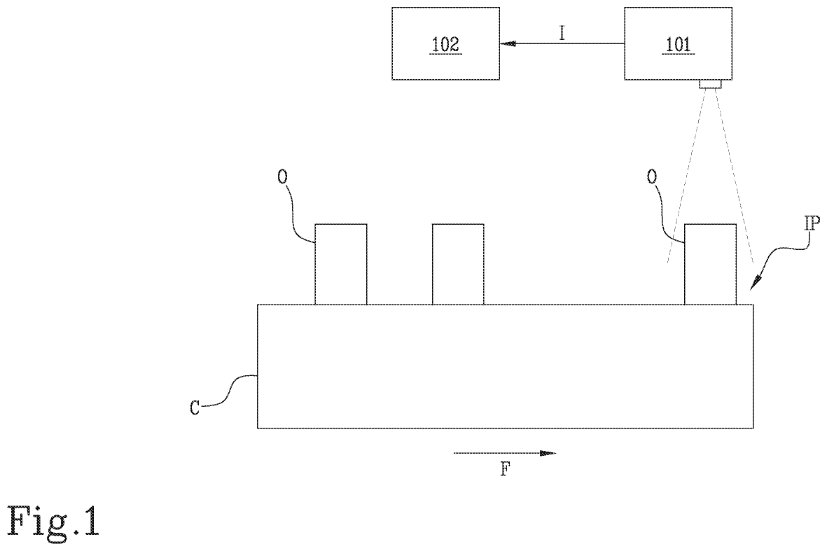

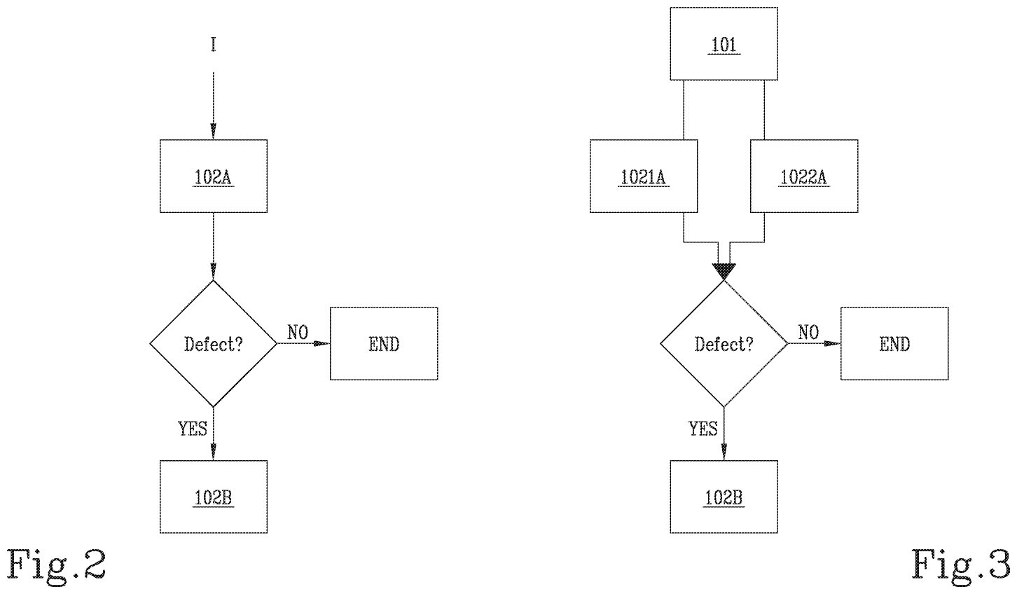

### DETAILED DESCRIPTION OF PREFERRED EMBODIMENTS OF THE INVENTION

With reference to the accompanying drawings, the numeral 1 denotes a system for performing quality control of objects in an apparatus which produces the objects O in continuous cycle. The system 1 comprises an optical device 101. The optical device 101 is configured to capture an image I of each object O located in an inspecting station IP. In another example, the optical device 101 è configured to capture a plurality of images of each object. In an example, the optical device 101 includes a camera.

The optical device 101 includes an illuminator, for illuminating the object in the inspecting station. Preferably, the illuminator is configured for illuminating the object in the inspecting station IP with light in the spectrum of visible light, or IR or UV. Moreover, the optical device includes the camera, configured for viewing the object in the inspecting station.

In one example, the image I that is acquired for each object O positioned in the inspection station is representative of the visible appearance of the object. In other words, in one example, each object is illuminated with light in the visible spectrum. In one example, the object may be exposed to infrared radiation. According to one example, the object O, in the inspection station, is exposed to a light in the spectrum of visible light, or IR or UV (more generally, the light is in a spectrum other than that of X-rays). In particular, the image obtained for each object illustrates visible aspects of the object. The image obtained for each object is an image (representative) of the whole object.

The system 1 may also comprise a conveyor C. The conveyor C is configured to feed the objects O individually to the inspecting station IP. In other words, in a preferred embodiment, the objects are conveyed to the inspecting station one at a time. In this solution, each object is delivered to the inspecting station with a predetermined orientation. Furthermore, each object may be illuminated according to a predetermined orientation in the inspecting station. In another example, the conveyor may be configured to feed the objects in a disordered flow so that more than one object is present in the inspecting station at any one time. Thus, the captured image of the objects in the inspecting station may include more than one object. The conveyor is configured to feed the objects O in a feed direction F. The system also comprises a processing unit 102. The processing unit 102 is programmed to process each image in a first processing step. The processing unit 102 is configured to attribute the image I and the corresponding object O to one of the two following categories: defective objects category and non-defective objects category.

The processing unit 102 is also configured, in a second processing step, to process image data relating to each image I attributed to the defective objects category. The processing unit 102 is configured to process the image data relating to each image I attributed to the defective objects category responsive to an outcome of the first processing step. In an example, the processing unit 102 is configured to process only image data relating to the images attributed to the defective objects category. The processing unit 102 is configured to perform the second processing step to classify the image and the corresponding object according to a plurality of defect categories. The processing unit 102 is configured to classify the image and the corresponding object based on a plurality of identification features. In an example, the plurality of identification features is extracted from the image data.

In an example, the processing unit 102 comprises a storage unit. The storage unit 1021 is configured to store the images which are attributed to the defective objects category in a diagnostic database. Furthermore, in an example, the images attributed to the non-defective objects category are eliminated. Preferably, the storage unit includes a non-volatile memory.

In an example, the processing unit is configured to obtain position information related to the position of a defect in each defective object O in the first processing step.

In an example, in the first processing step 102A, the processing unit 102 includes a machine-learned model. The machine-learned model is trained to attribute each image to the defective objects category or to the non-defective objects category. The machine-learned model is trained based on training data. In an example, the training data includes only images of non-defective objects.

Moreover, in the first processing step, the processing unit includes, for each image, extracting diagnostic markers from the image data. In the first processing step, the processing unit includes, for each image, applying predetermined diagnostic rules.

More specifically, each image taken of the object to be inspected provides a set of pixels and a defect may take the form of an incongruent area such as, for example, a different value of luminous intensity or colour which contrasts with the area that contains it (non-defective zone). The value of the contrast depends on the variability of the intensity compared to the non-defective object and is generally different in each point of the image to be inspected. This definition applies to defects that take the form of areas of uniform colour.

For textured areas, a defect may take the form of an area of pixels containing variations (that is, contrasts) when compared to what are considered normal variations in shade or colour (including positional ones) on a non-defective object. Thus, a change in texture can be considered a defect.

In an example, in the first processing step 102A, the processing unit 102, at a first stage, includes a machine-learned model. The machine-learned model is trained to attribute each image to the defective objects category or to the non-defective objects category. The machine-learned model is trained based on training data. The training data includes only images of non-defective objects.

Furthermore, in an example, in the second processing step 102B, the processing unit 102 includes, for each image, extracting diagnostic markers from the image and applying predetermined diagnostic rules, at a second stage.

More specifically, both the outcome of the first stage and the outcome of the second stage of the first processing step are taken into consideration for attributing the image and the corresponding object to the defective objects category or to the non-defective objects category.

In an example, the processing unit 102 is configured to perform an unsupervised clustering in the second processing step 102B. The unsupervised clustering is programmed to illustrate each image data as a data point in a working space. In particular, the workspace has multiple dimensions. Each dimension corresponds to one feature of the plurality of identification features. Values of said identifying features extracted for each image (provide an array that consituteds, for that image, a plurality of coordinates in the working space, thus identifying a point in the working space) define the position of the image data of each image in the working space, so that each image data can be represented as a (data) point in the working space. The unsupervised clustering is programmed to generate the defect categories by grouping data points that have similar locations in the working space. Therefore, according to one example, for each image acquired for each object, a plurality of identifying features is extracted from the image data of each image and the value of each feature extracted from the image data of each image determines the location of the image data. of that image in the workspace.

More specifically, by “unsupervised clustering” is meant a grouping system for subdividing the data points in the working space into groups in an unsupervised manner. In other words, the unsupervised grouping system (that is, the unsupervised clustering) divides the data points in the working space based on the positional similarity of the data points in the working space and, consequently, creates different groups of data points (or defect categories) in the working space. The unsupervised clustering can also label each group of data points in the working space.

According to an aspect of it, this disclosure provides a method for performing quality control of objects O in an apparatus which produces the objects in continuous cycle. The method comprises a step of feeding the objects O individually to an inspecting station IP. In other words, in a preferred embodiment, the objects are conveyed to the inspecting station one at a time. In this solution, each object is delivered to the inspecting station with a predetermined orientation. The method may also include a step of illuminating each object according to a predetermined orientation in the inspecting station. In another example, the method may comprise a step of feeding the objects in a disordered flow so that more than one object is present in the inspecting station at any one time. Thus, the image of the objects taken in the inspecting station may include more than one object. The method comprises a step of capturing an image I for each object O positioned in the inspecting station IP. The method also comprises a step, for each image, of applying a first processing step 102A.

The first processing step 102A is performed for attributing the image and the corresponding object to one of the two following categories: defective objects category and non-defective objects category. The first processing step may comprise extracting features from input data (that is, images).

The extracted data are processed in the first processing step in order to detect defects. Further, if the image is attributed to the defective objects category, the method comprises a step of applying a second processing step 102B to image data. The image data is from each image. The image data may be data from a raw image of the object. The image data may be semi-processed data derived from the first processing step 102A. The second processing step 102B is performed to classify the image I and the corresponding object O according to a plurality of defect categories. Classification of the defects is performed on the basis of a plurality of identification features. In an example, the identification features are extracted from the image I. In an example, the second processing step 102B is applied only to the objects attributed to the defective objects category.

The method also comprises a step of storing in a (diagnostic) database the images which are attributed to the defective objects category. In an example, the images attributed to the non-defective objects category are excluded from the storing step. Preferably, the images attributed to the non-defective objects category are eliminated.

In an example, the first processing step 102A is performed by a machine-learned model. The machine-learned model is trained to attribute each image to the defective objects category or to the non-defective objects category. The machine-learned model is trained based on training data. In an example, the training data may include only images of non-defective objects.

Moreover, the first processing step 102A may include, for each image I, extracting diagnostic markers from the data of the image I. The first processing step 102A may include applying predetermined diagnostic rules. In an example, for each image, a map of the diagnostic markers extracted from each image is obtained. The predetermined rules (or algorithms) are applied to the map to identify defects, if any, in the image and in the corresponding object.

For example, the defect may be in the form of a variation in the luminosity of a part of the image, resulting in a contrast in that area. Thus, detecting a difference of this kind on the map means that a defect has been detected. In an example, the first processing step 102A, at a first stage 1021A, includes the machine-learned model. Further, the step of extracting the diagnostic markers is performed in a second stage 1022A of the first processing step 102A. In an example, the processing steps of the first stage and of the second stage are performed concurrently.

Further, during the first processing step 102A, position information related to the position of a defect in each defective object is obtained. The position information is fed to the second processing step 102B. In an example, the plurality of identification features includes at least one feature representative of the position information. In an example, the position information is obtained at the second stage of the first processing step 102A.

In an example, an unsupervised clustering is used in the second processing step 102B. During the unsupervised clustering, each image data is represented as a data point in a working space and the defect categories are generated by grouping data points that have similar locations in the working space. In an example, if it is not possible to recognize at least two distinct data points in the working space, the system attempts to show a second set of data points to distinguish groups of data points. Through an interface, a user can also add a new defect category or modify (highlight, separate or label) the defect categories that have already been recognized. In an example, both the outcome of the first stage and the outcome of the second stage of the first processing step 102A are taken into consideration for attributing the image and the corresponding object to the defective objects category or to the non-defective objects category.

In an example, in the second processing step, output data of both the first stage and the second stage of the first processing step 102A are sent as input to the second processing step. More specifically, in the second processing step 102B, output data of both the first stage and the second stage of the first processing step 102A are received and processed in combination with each other.

In an example, in the first processing step, both the first stage and the second stage are applied to each image data obtained from each object. Thus, each image obtained from each object may be checked and attributed to the defective objects category or to the non-defective objects category either by the machine-learned model or by extracting diagnostic markers from the image data and applying predetermined diagnostic rules. Further, in an example, the image data of each object may, in the first processing step, be divided into a first subset and a second subset according to predetermined criteria. In this solution, for each object, the first stage is applied to the first subset and the second stage is applied to the second subset. For example, a predefined fraction of an object is analysed using the machine-learned model and another predefined fraction is analysed by extracting diagnostic markers from the image data and applying predetermined diagnostic rules (for example, an artificial neural network). Thus, according to a predetermined criterion, image data of each object can be subdivided into a first subset and a second subset and a combination of the first stage and the second stage can be applied to each object.

The first processing step may also include a plurality of tasks. The plurality of tasks can provide a corresponding plurality of conditions to be met according to a predetermined sequence. The plurality of conditions to be met may relate to the objects to be checked. In this solution, a first group of tasks may be performed by the machine-learned model, and a second group of tasks may be performed by extracting diagnostic markers from the image data and applying predetermined diagnostic rules.

According to an aspect of it, this disclosure provides an apparatus for producing objects in continuous cycle. The apparatus comprises one or more machines for producing the objects. The apparatus also comprises a system 1 for performing quality control of the objects, wherein the system 1 is according to this disclosure.

According to another aspect of it, this disclosure provides a computer program. The computer program comprises instructions configured for performing the steps of the method according to this disclosure.

1. A method for performing quality control of objects in an apparatus which produces the objects in continuous cycle, the method comprising the following steps:
feeding the objects individually to an inspecting station;
for each object positioned in the inspecting station, capturing an image;
for each image, applying a first processing step, for attributing the image and the corresponding object to one of the two following categories: defective objects category and non-defective objects category;
if the image is attributed to the defective objects category, applying to image data related to that image a second processing step, and further classifying, based on a plurality of identification features extracted from the image data, the image and the corresponding object according to a plurality of defect categories.

2. The method according to claim 1, wherein the optical device illuminates the object in the inspecting station with light in the spectrum of visible light, or IR or UV, and includes a camera, wherein the camera views the object and takes the image of the object.

3. The method according to claim 1, comprising a step of storing in a database the images which are attributed to the defective objects category.

4. The method according to claim 3 wherein an unsupervised clustering is used in the second processing step, wherein during the unsupervised clustering, a working space having multiple dimensions is defined, wherein each dimension corresponds to a feature of the plurality of identification features extracted from the image data of each image, wherein values of said identification features extracted for each image define the location of the image data of each image in the workspace, so that each image data is represented as a data point in the working space and the defect categories are generated by grouping data points that have similar locations in the working space.

5. The method according to claim 3 wherein the images attributed to the non-defective objects category are excluded from the storing step.

6. The method according to claim 1, wherein during the first processing step position information related to the position of a defect in each defective object is obtained.

7. The method according to claim 6, wherein the position information is fed to the second processing step.

8. The method according to claim 7, wherein the plurality of identification features includes at least one feature representative of the position information.

9. The method according to claim 1, wherein the first processing step is carried out through a machine-learned model trained to attribute each image to the defective objects category or to the non-defective objects category, wherein the machine-learned model is trained based on training data including only images of non-defective objects.

10. The method according to claims 1, wherein the first processing step includes, for each image, extracting diagnostic markers from the image data and applying predetermined diagnostic rules.

11. The method according to claim 1, wherein the first processing step includes:
a machine-learned model trained to attribute each image to the defective objects category or to the non-defective objects category, and
for each image, extracting diagnostic markers from the image data and applying predetermined diagnostic rules, at a second stage,
wherein both the outcome of the first stage and the outcome of the second stage of the first processing step are taken into consideration for attributing the image and the corresponding object to the defective objects category or to the non-defective objects category.

12. The method according to claim 11, wherein, during the first processing step, one of the following conditions occurs:
i) both the first stage and the second stage are applied to the image data taken from each object;
ii) according to predetermined criteria, the image data of each object is divided into a first subset and a second subset, wherein, for each object, the first stage is applied to the first subset and the second stage is applied to the second subset;
iii) the first processing step includes a plurality of predetermined tasks, providing a corresponding plurality of conditions to be met according to a predetermined sequence,
wherein a first group of tasks of the plurality of tasks is performed by the machine-learned model, and a second group of tasks of the plurality of tasks is performed by extracting diagnostic markers from the image data and applying predetermined diagnostic rules.

13. A system for performing quality control of objects in an apparatus which produces the objects in continuous cycle, the system comprising:
an optical device configured to capture an image of each object located in an inspecting station;
a conveyor for feeding the objects individually to the inspecting station;
a processing unit programmed to:
process each image in a first processing step for attributing the image and the corresponding object to one of the two following categories: defective objects category and non-defective objects category,
process, in a second processing step, responsive to an outcome of the first processing step, image data related to each image attributed to the defective objects category, for classifying the image and the corresponding object according to a plurality of defect categories based on a plurality of identification features extracted from the image data.

14. The system according to claim 13, further comprising a storage unit configured to store the images which are attributed to the defective objects category in a database.

15. The system according to claim 14, wherein the processing unit is configured to perform an unsupervised clustering in the second processing step, the unsupervised clustering being programmed to defining a multiple-dimensional working space, wherein each dimension corresponds to a feature of the plurality of identification features extracted from the image data of each image, wherein values of said identification features extracted for each image define the location of the image data of each image in the workspace, so that each image data is illustrated as a data point in the working space and the unsupervised clustering being programmed to generate the defect categories by grouping data points that have similar locations in the working space.

16. The system according to claim 13, wherein the processing unit is configured to obtain position information related to the position of a defect in each defective object in the first processing step.

17. The system according to claim 13 wherein the processing unit, in the first processing step, includes a machine-learned model which is trained to attribute each image to the defective objects category or to the non-defective objects category, wherein the machine-learned model is trained based on training data including only images of non-defective objects.

18. The system according to claim 13 wherein the processing unit, in the first processing step, includes, for each image, extracting diagnostic markers from the image data and applying predetermined diagnostic rules.

19. The system according to claim 13 wherein the processing unit, in the first processing step, includes:
a machine-learned model which is trained to attribute each image to the defective objects category or to the non-defective objects category, and
for each image, extracting diagnostic markers from the image data and applying predetermined diagnostic rules, at a second stage,
wherein both the outcome of the first stage and the outcome of the second stage of the first processing step are taken into consideration for attributing the image and the corresponding object to the defective objects category or to the non-defective objects category.

20. The system according to claim 13, wherein the optical device includes
an illuminator, for illuminating the object in the inspecting station with light in the spectrum of visible light, or IR or UV;
a camera, configured for viewing the object in the inspecting station and for taking takes the image of the object.

21. An apparatus for producing objects in continuous cycle, the apparatus comprising:
one or more machines for producing the objects,
a system for performing quality control of the objects, wherein the system is according to claim 13.

22. A computer program including instructions configured for executing the steps of the method according to claim 1 when run on a processor.
